(19) United States
(12) Patent Application Publication
(10) Pub. No.: US 2008/0226510 A1
(43) Pub. Date: Sep. 18, 2008

(54) Extensional Flow Layer Separating Reactor

(76) Inventors: Ulrich Riebel, Briesen (DE); Urs Peuker, Clausthal-Zellerfeld (DE)

Correspondence Address: THELEN REID BROWN RAYSMAN & STEINER LLP, P.O. BOX 640640, SAN JOSE, CA, 95164-0640, US

(21) Appl. No.: 12/089,710

(22) PCT Filed: Sep. 21, 2006
(86) PCT No.: PCT/EP2006/009192

§ 371 Date: Apr. 10, 2008

(30) Foreign Application Priority Data
Oct. 10, 2005 (DE) 10 2005 048 352.6
Feb. 13, 2006 (DE) 10 2006 006 566.2

(51) Int. Cl. B01J 19/10; B01J 19/26

(52) U.S. Cl. 422/128; 422/224; 422/127

(57) ABSTRACT

The invention relates to a extensional flow layer-separating reactor comprising a channel, in which at least two educt products and at least one separation fluid for spatially separating said two products are introduced, an extension area which is adjacent to the channel in such a way that the educt product and the separation fluid which are drawn in substantially laminar layers, flow at a greater speed and a turbulence generating device for generating the turbulent micro mixture of the educt products.

The invention relates to a reactor that can be used to perform, in particular, very fast precipitation reactions in liquid phase.

If fast precipitation reactions are to be performed in liquid phase, a rapid mixing of the two reaction solutions, each exhibiting a high supersaturation, must occur. Therefore, such reactions are usually trigged by turbulent mixing, whereby the process may be aided, in part, by ultrasound action. Considering known methods, it is disadvantageous that a premature precipitation of reaction products already occurs at the boundaries surfaces during the first mixing phase, the so-called macro-mixing. As a result of this, it is frequently not possible in the case of such reactions to achieve an actually desirable narrow particle size distribution, in particular, when very fine particle sizes are concerned.

However, many important applications require just such products exhibiting a very narrow particle size distribution within the range of under 1 micrometer down to a few nanometers. Such applications are, for example, catalysts, pigments, ceramic powders, electroceramic mixed oxides, magnetic particles and fluids, pharmaceutical, medical and cosmetic products.

Precipitation is by far the least expensive method for the production of small particles. The problem is that, considering the available precipitation methods, particles having a diameter of <100 nm cannot be reliably and reproducibly produced. In this instance, the conventional precipitation in a stirred tank reactor will fail.

The mixing speed plays a decisive part in particle size distribution. In case of a very rapidly proceeding chemical precipitation in a stirred tank reactor, the mixing speed used for mixing the reactants is lower than the rate of nucleation. In addition, in such a reactor, particles that have been precipitated in a diffusion-controlled manner already come continuously into contact with freshly added reactants, as well as with the nuclei resulting therefrom. Ultimately, this leads to uncontrollable particle growth and to various particle sizes.

The prerequisites for a precipitation with high-quality nano-particles are:
Any reverse mixing of already precipitated particles with fresh reaction components must be excluded;
The reaction components must be mixed rapidly enough so that mixing is completed before the first nuclei or so-called particles have formed.

Considering these prerequisites, a maximum supersaturation occurs and the formation of all nuclei takes place synchronously.

Continuous mixers of conventional design, known as Y-mixers or T-mixers, indeed permit limited precipitations without reverse mixing; however, the desired high mixing speeds cannot be achieved with these mixers.

In the so-called MicroJetReactor in accordance with document EP 1 165 224 A1, two fine fluid jets collide with the reactants in the form of dissolved components (so-called impinging jets) in the center of a gas-filled space. A gas jet is injected into the reaction space through a third orifice, said jet carrying the reaction products out through a fourth oppositely located orifice. The small diameter (approx. 200 μm) and the high speed of the jets (e.g., 100 m/s), together with high shearing forces, achieve very rapid and intense mixing, as well as the precipitation of the insoluble reaction products.

It is the object of the present invention to provide a reactor with which, in particular, very fast precipitation reactions can be performed in the liquid phase in such a manner that the reaction product can be produced exhibiting a very narrow particle size distribution with particle sizes within the micrometer range to the nanometer range.

In accordance with the invention, this object is achieved by an extensional flow layer-separating reactor displaying the features of Claim 1. To achieve this, an extensional flow layer-separating reactor comprises a channel, in which at least two educts and at least one separation fluid for spatially separating said two educts are introduced. In addition, an extension zone is provided, said extension zone being adjacent to the channel in such a way that the educt and the separation fluid which are drawn in substantially laminar layers, flow at a greater speed. This is followed by a turbulence-generating device for generating the turbulent micro-mixture of the educts.

The extensional flow layer-separating reactor in accordance with the present invention permits mixing in the following steps:
The educts are respectively injected in the form of a laminar flow into the channel. In so doing, a non-reactive fluid, e.g., water, is injected as the separation layer between the two educt layers, so that, initially, no reaction may take place.
By accelerating the laminar flow in a convergent slot nozzle, the educts and the separation fluid are drawn at high speed into very thin laminar flow layers. In so doing, e.g., layer thicknesses of 0.2 mm and flow rates of 100 m/s are achieved, without a reaction occurring already at this time.
In an adjoining turbulence-generating device, very strong turbulences are generated, so that complete mixing of the thin layers occurs within a very short flow distance.

By using this process, the extensional flow layer-separating reactor in accordance with the invention permits a particularly suitable implementation of a precipitation reaction, whereby particularly fine-grained, crystalline and amorphous precipitation products can be prepared. In addition, it is also possible to carry out reactions, in which the reaction product would otherwise prevent the mixing of the reactants. For example, this is applicable to a rapid polymerization, in which case the polymer greatly increases the viscosity of the solution.

Special embodiments of the invention are obvious from the subclaims that follow the main claim.

Accordingly, the turbulence-generating device may comprise a divergent expansion of the slot nozzle. Alternatively, the turbulence-generating device may be an impingement plate located opposite the slot nozzle. In order to create turbulences, it is also possible to design the turbulence-generating device as a fluid reservoir located opposite the slot nozzle or as a resonance space with self-excitation or foreign excitation.

Basically, the channel may be a flat, essentially two-dimensional flow channel.

The educts may be laterally injected into the channel, while the separation fluid is centrally injected into said channel. Guide baffles may be arranged in the inflow region of the educts, said guide baffles permitting a safe separation of the educt layers from the inflowing separation-fluid layers.

In addition to the separation fluid in the region between the educts, separation fluid may also be guided in the region between the educts and the respective channel wall.

In accordance with one embodiment the channel may be configured as a flat, essentially two-dimensional flow channel. Another modification is that the channel is configured as a rotation-symmetrical body, in which the educts and the separation fluid are sequentially injected onto the circumference as a tangential flow.

Furthermore, the rotation-symmetrical channel may contain a cone for flow guidance, said cone effecting the formation of the rotational flow and guiding of the flow toward the opening of the rotation-symmetrical channel.

Additional features, details and advantages of the invention will be explained with reference to various exemplary embodiments as shown by the drawings. They show in:

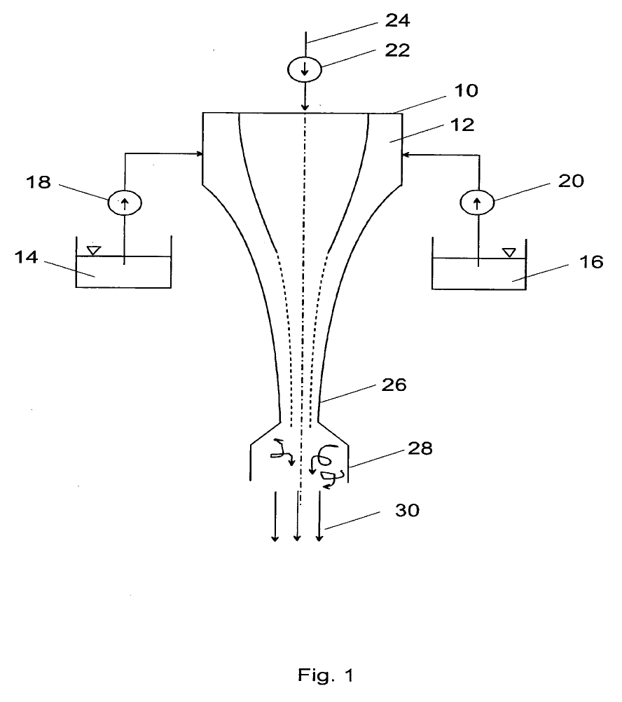

FIG. 1 a schematic general arrangement drawing of an extensional flow layer-separating reactor in accordance with a first embodiment of the present invention;

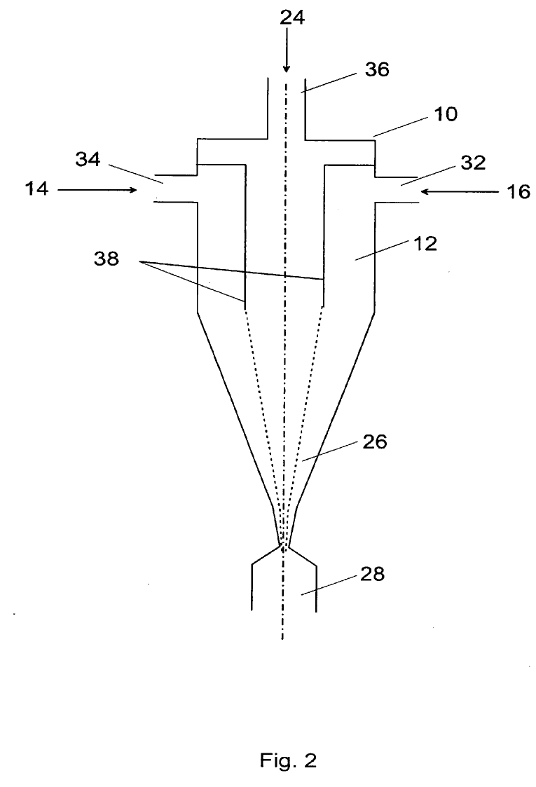

FIG. 2 a sectional view of an extensional flow layer-separating reactor that has been slightly modified compared with the embodiment in accordance with FIG. 1;

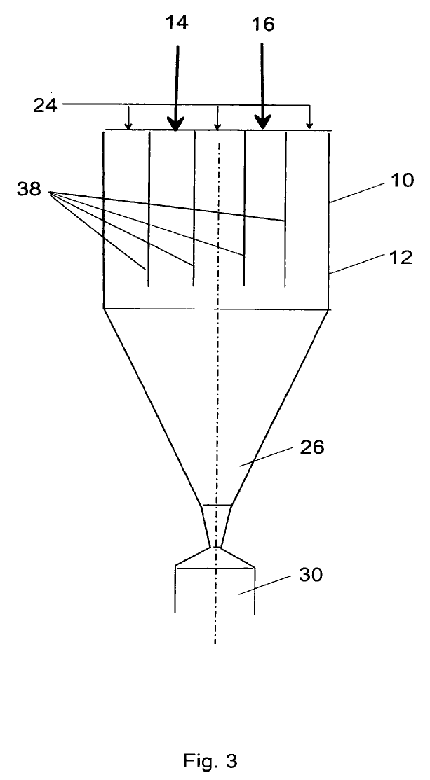

FIG. 3 an extensional flow layer-separating reactor in accordance with another embodiment of the invention;

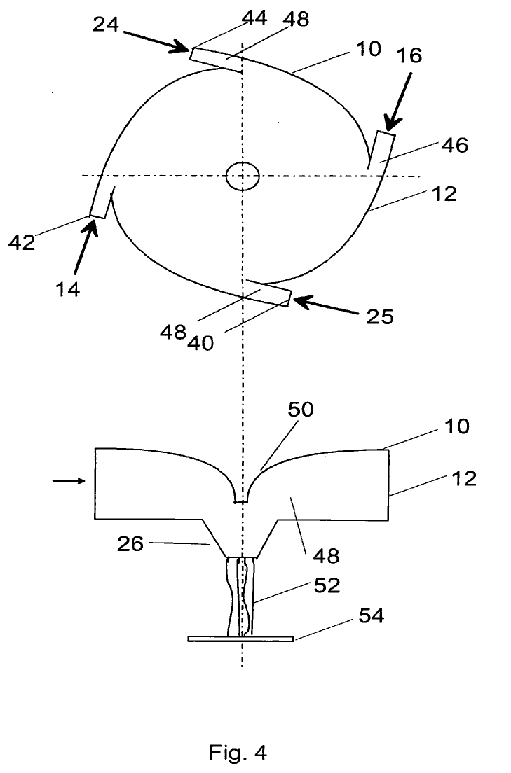

FIG. 4 an additional alternative embodiment of an extensional flow layer-separating reactor in accordance with the present invention; and,

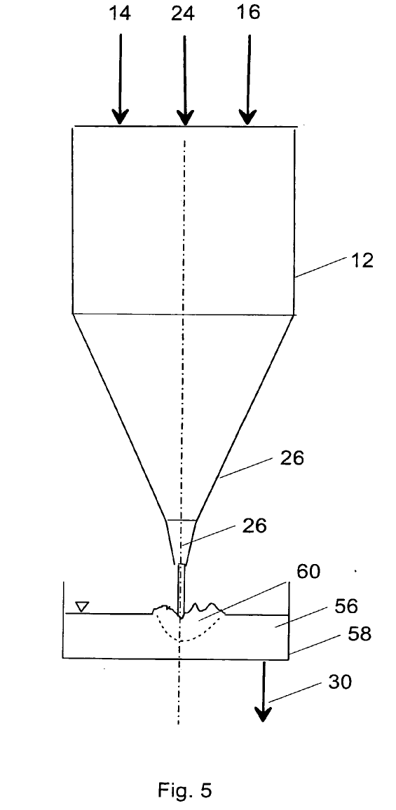

FIG. 5 again, another alternative embodiment of an extensional flow layer-separating reactor in accordance with the present invention.

The extensional flow layer-separating reactor 10 shown in FIG. 1 initially comprises a flat channel 12. On opposing sides, an educt A 14 and an educt B 16 are injected. For injection, appropriate injection pumps 18 and 20 are shown. In the center from the top, a separation fluid 24—e.g., water—is injected via a pump 22 into the channel 12. It is essential that the separation fluid 24 not react with the educts 14 and 16. The separation fluid may be miscible or non-miscible with the educts. A laminar layer flow comprising three layers, namely the educt A, the separation fluid and the educt B, is formed as shown by FIG. 1.

An extension zone (acceleration zone) 26 is adjacent the channel 12, whereby, in the present case, said zone comprises a convergent, tapering slot nozzle 26. As a result of this, the laminar flow is drawn into very thin layers flowing in a laminar manner at high speed. In so doing, for example, layer thicknesses of 0.2 mm and flow rates of 100 m/s are achieved, without a reaction between the educts taking place here.

Referring to FIG. 1, the slot nozzle 26 is followed by the turbulence-generating device 28, it representing a divergent expansion in this exemplary embodiment. Here, sudden strong turbulences are generated so that, within a very short flow distance, a complete mixing of the thin layers is achieved, i.e., the best possible mixing is achieved. In the end, the fine-grained product 30 is extracted from the extensional flow layer-separating reactor 10.

FIG. 2 shows an extensional flow layer-separating reactor 10 which essentially corresponds to the setup in accordance with FIG. 1. Here, the respective inlets 32, 34 and 36 for the educts A and B, as well as for the separation fluid, are shown. Referring to this design, guide baffles 38 are provided within the channel 12, said guide baffles resulting in a separation of the respective flows of the educt A, the educt B and the separation fluid in the inflow region, i.e., in the region of the inlets 32, 34 and 36.

FIG. 3 shows a slightly modified extensional flow layer-separating reactor 10 in accordance with FIGS. 1 and 2. Here, the separation fluid 24 is injected from the top at three locations, whereby, also from the top, layers—initially the educt A 14 and the educt B 16—are injected between the separation fluid into the channel 10. Metal separating-sheets 38 are arranged between the injection regions of the separation fluid 24 and the educts A and B 14 and 16, said separating sheets ensuring an initial separation of the flows. Referring to this embodiment, a separation fluid is injected between the educt A and the wall of the channel 10 or the educt B and the wall of the channel 10, so that an undesirable contact between the educt A and the educt B, respectively, and the wall of the channel 12 is avoided.

FIG. 4 shows an alternative embodiment of an extensional flow layer-separating reactor 10. At the top is a plan view of the channel 12, and at the bottom is a sectional view of the channel 12. Here, it becomes clear that the channel comprises a rotation-symmetrical arrangement and that it has four inlets 40, 42, 44 and 46 for the tangential injection of the educt A 14, a first separation fluid 24, the second educt B 16, and a second separation fluid 25. As a result of the tangential injection of this flow component, a rotary flow 48 is created, said flow being aided in the rotation-symmetrical channel 12 by the centrically arranged cone 50. The rotation-symmetrical channel 12 is followed—centrally below—by the slot nozzle 26 for drawing the educt flow and the separating-fluid flow, respectively, whereby, considering this modification, the laminar flow layers move in a rotating motion toward the orifice in order to then exit as the free jet 52. By impinging on an impinging plate 54, sudden turbulent micro-mixing is achieved.

FIG. 5 again shows an alternative embodiment of the invention. Basically, this is a similar embodiment as that shown by FIGS. 1 and 3, whereby here the educt A 14 and the educt B 16 are injected laterally at the top into the channel 12, whereby the separation fluid 24 is injected centrally from the top. In this case, the channel 12 is again adjacent the convergent, tapering slot nozzle 26, from where the still separate layers exit in a free jet. This free jet is injected into a fluid 56 contained in a container 58. In a mixing zone 60, the free jet impinges on the fluid 56 and results in rapid turbulent micro-mixing. The product 30 can be extracted from the container 58.

1. Extensional flow layer-separating reactor comprising a channel, in which at least two educts and at least one separation fluid for spatially separating said two educts are introduced, comprising an extension area which is adjacent to the channel in such a way that the educt and the separation fluid, which are drawn in substantially laminar layers, flow at a greater speed, and comprising a turbulence-generating device for generating the turbulent micro mixture of the educts.

2. Extensional flow layer-separating reactor in accordance with claim 1, wherein the turbulence-generating device is a divergent expansion of the nozzle.

3. Extensional flow layer-separating reactor in accordance with claim 1, wherein the turbulence-generating device is an impinging plate located opposite the nozzle.

4. Extensional flow layer-separating reactor in accordance with claim 1, wherein the turbulence-generating device is a fluid reservoir located opposite the nozzle.

5. Extensional flow layer-separating reactor in accordance with claim 1, wherein the turbulence-generating device is a resonator.

6. Extensional flow layer-separating reactor in accordance with claim 1, wherein the turbulence-generating device is configured in such a manner that a sound jet or ultrasound jet is directed obliquely or perpendicularly at the laminar layer flow.

7. Extensional flow layer-separating reactor in accordance with one of the previous claims, wherein the channel is configured as a flat flow channel.

8. Extensional flow layer-separating reactor in accordance with claim 1, wherein the educts are laterally injected into the channel, while the separation fluid is injected in the middle between said educts.

9. Extensional flow layer-separating reactor in accordance with claim 1, wherein t guide baffles are arranged in the inflow region of the educts.

10. Extensional flow layer-separating reactor in accordance with claim 1, wherein, in addition, separation fluid may be guided in the region between the educts and the channel wall.

11. Extensional flow layer-separating reactor in accordance with claim 1, wherein t the channel is configured as a rotation-symmetrical body into which the educts and the separation fluid are sequentially injected onto the circumference as a tangential flow.

12. Extensional flow layer-separating reactor in accordance with claim 11, wherein, for guiding the flow, a cone is centrically arranged in the rotation-symmetrical channel.

13. Extensional flow layer-separating reactor in accordance with claim 1, wherein the extension zone for the generation of a layer flow comprises a consistently tapering layer nozzle.

14. Extensional flow layer-separating reactor in accordance with claim 1, wherein the extension zone for the generation of a rotational flow comprises a consistently tapering round nozzle.

15. Extensional flow layer-separating reactor in accordance with claim 1, wherein the extension zone comprises a consistently tapering nozzle and a free jet.
